(19) United States
(12) Patent Application Publication
(10) Pub. No.: US 2017/0173812 A1
(43) Pub. Date: Jun. 22, 2017

(54) APPARATUS AND METHOD FOR ROTARY KISS CUT LINER EFFICIENCY

(71) Applicant: Delta Industial Services, Inc., Minneapolis, MN (US)

(72) Inventors: Joel Oakes, Minneapolis, MN (US); Evan Schiebout, Oak Grove, MN (US)

(21) Appl. No.: 15/377,681

(22) Filed: Dec. 13, 2016

Related U.S. Application Data
(60) Provisional application No. 62/268,017, filed on Dec. 16, 2015.

(51) Int. Cl. B26D 7/20; B26D 5/00; B26D 1/40

(52) U.S. Cl. CPC B26D 7/204; B26D 1/405; B26D 5/005

(57) ABSTRACT

This document discusses, among other things, methods and apparatus for a liner efficient kiss-cut die station. In an example, a method can include indexing a length of liner into a rotary die station and performing multiple kiss-cut cycles of a web material using the length of liner. In some examples, the length of liner is a backing material for each kiss-cut cycle of the multiple kiss-cut cycles. In some examples, each kiss-cut cycle of the multiple kiss-cut cycles is configured to completely cut through a new length of the web material.

### PRIORITY AND RELATED APPLICATIONS

This application claims the benefit of priority under 37 CFR 119(e) to Oakes et. al, U.S. Provisional Patent Application No. 62/268,017, filed Dec. 16, 2015, title, “APPARATUS AND METHOD FOR ROTARY KISS CUT LINER EFFICIENCY”, which is hereby incorporated by reference herein in its entirety.

### TECHNICAL FIELD

This application relates generally to automated web processing systems, and more particularly, to methods and apparatus for using liner in a rotary kiss-cut operation.

### BACKGROUND

Die cutting can be a versatile fabrication process and is used in a number of manufacturing processes to cut, form and shape sheet and rolled metal. A highly accurate and speedy process, custom-shaped die cutting can come in a variety of different methods, such as flatbed, press, laser and rotary die cutting. Rotary die cutting functions well on high-volume projects, producing little waste and featuring quick turnover times.

A rotary die cutting station can include a heavy cylindrical anvil with a customized die which roles over a flat surface of the anvil to cut web material positioned between the anvil and the customized rotary die. The rotary die cutting station can be fed sheet metal, paper or plastic, either from a spindle roll or flat individual pieces, which then passes through the rolling die. After the rotary die cutting station cuts or perforates the desired shape from the material and deposits the finished shape down a line, waste material can be directed to a waste container or if the die cutting results in a web matrix, can be rewound for later disposal.

Challenges can arise for certain materials as cut quality of metal on metal die cutting can change significantly as the die ages. In certain examples, the aging process of the die can be quite rapid, for example within a tens of cut cycles. Although the die can still function, the resulting cuts can exhibit fraying. Even minuscule fraying can create a competitive disadvantage for a product that open the possibility for competitors to exploit.

A general solution to rotary cut materials without producing fraying includes using a soft anvil or a kiss-cut operation. However, both of these procedures have shortcomings that can increase production costs significantly. Using a softer anvil material can allow clean cut of materials even as the blades of the die begin to dull. However, soft material anvils wear faster than hard anvils and, therefore, need to be replaced significantly more often. A kiss-cut involves having a liner material back-up the production material during the die cut operation. As both material pass between the die and anvil, the die cuts completely through the production material and partially penetrates the liner material to provide a clean and generally fray-free cut of the production material. However, the process involves using an additional material, the liner that is not a functional material of the end product. In addition to the material costs, production costs also increase as the material needs to be periodically replenished on the machine and also disposed of.

### SUMMARY

This document discusses, among other things, methods and apparatus for a liner efficient kiss-cut die station. In an example, a method can include indexing a length of liner into a rotary die station and performing multiple kiss-cut cycles of a web material using the length of liner. In some examples, the length of liner is a backing material for each kiss-cut cycle of the multiple kiss-cut cycles. In some examples, each kiss-cut cycle of the multiple kiss-cut cycles is configured to completely cut through a new length of the web material.

This Summary is an overview of some of the teachings of the present application and not intended to be an exclusive or exhaustive treatment of the present subject matter. Further details about the present subject matter are found in the detailed description and appended claims. Other aspects will be apparent to persons skilled in the art upon reading and understanding the following detailed description and viewing the drawings that form a part thereof, each of which are not to be taken in a limiting sense. The scope of the present invention is defined by the appended claims and their equivalents.

### BRIEF DESCRIPTION OF THE DRAWINGS

FIG. 1A illustrates generally an example of a kiss-cut die station according to the present subject matter.

FIG. 1B illustrates generally a cross-web, cross-section view of the kiss-cut die station of FIG. 1A

FIG. 1C illustrates generally an example web path associated with the example kiss-cut die station of FIGS. 1A and 1B.

FIG. 2 illustrates an alternative example of a kiss-cut die station according to the present subject matter.

FIG. 3 illustrates generally a flowchart of an example method according to the present subject matter.

FIG. 4 illustrates generally a block diagram of an example of a controller for controlling one or more of the illustrated examples of a kiss-cut die station.

### DETAILED DESCRIPTION

The present inventors have recognized apparatus and methods for saving material costs and production time loss for web or converting operations that benefit from rotary kiss-cut operations. As discussed above, in rotary web converting, there are materials that can be successfully die cut against a metal anvil roll. However, as margins for such products produced using these materials are squeezed, appearance of the final product including the appearance of the cut edge of the final cut material can become an important consideration. Some materials that can be cut using metal on metal rotary die cutting can exhibit fraying as the die ages. In some materials this may not happen for several thousand cycle, for other materials fraying can begin showing with tens of cycles of using a new die. As also discussed above, a known method of die cutting materials they may fray using metal-on-metal die cutting, is to use a liner material that is fed into the die cut operation with the material and kiss-cut the material and the liner such that the die passes completely through the material and partially cuts into the liner. The downside of such a solution is the added material and production costs associated with the liner.

In traditional liner backed kiss-cut operations, the length of liner material necessary for the operation is substantially equal to the length of production material targeted to be cut in the operation. In narrow web operations, the rolls of production materials and the liner materials are generally sized such that an operator or a small mobile jack can be employed to load new rolls of materials and unload rolls of waste materials. For rotary machines that operate around 50 feet per minute (fpm) to 200 (fpm), rolls of material may need to be changed every 20 minutes to every 2 hours. Adding a liner material to the operation can add significant production cost by adding additional material changes to the operation.

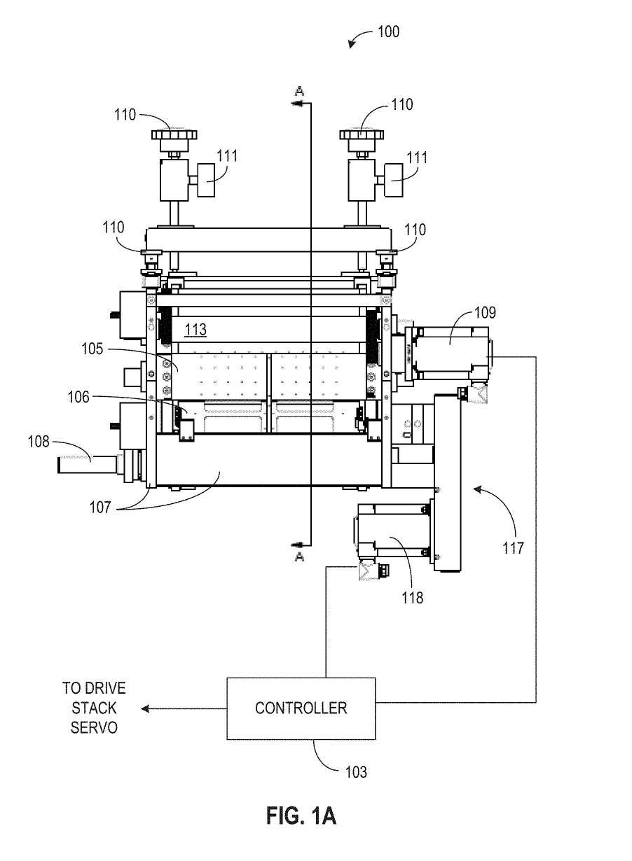

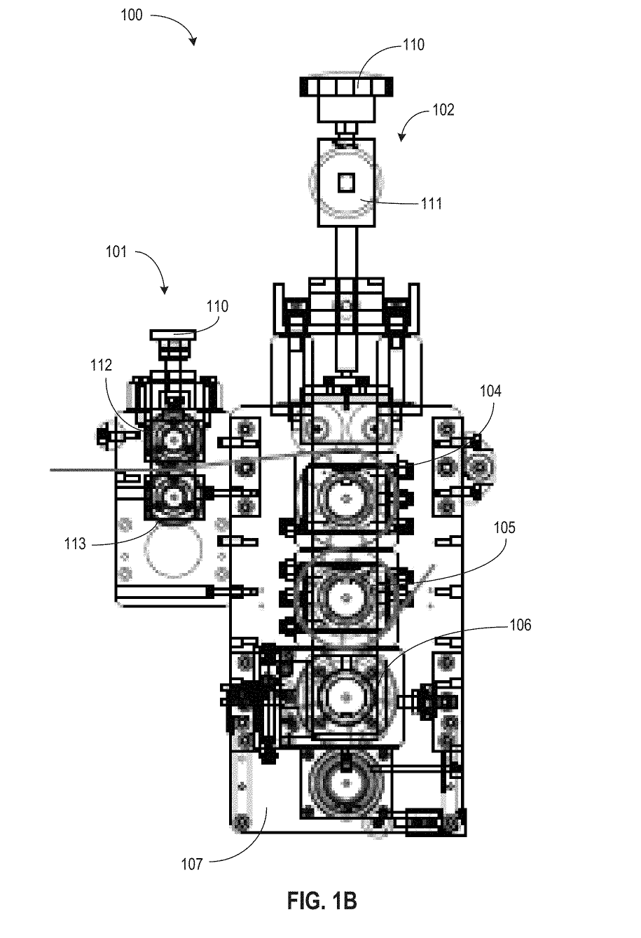

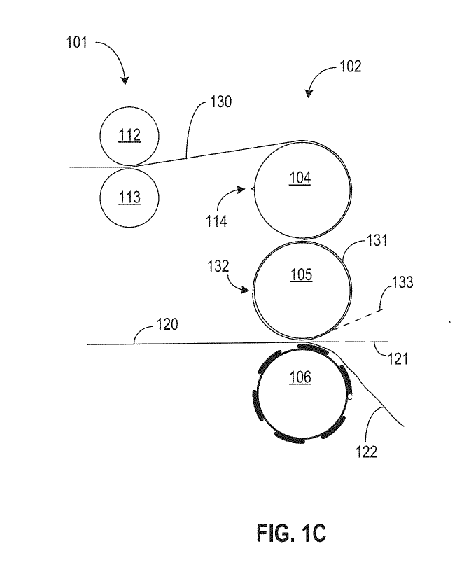

FIGS. 1A and 1B illustrate generally a detailed example kiss-cut die station 100 that can significantly reduce the material and production costs associated with adding a liner to provide a fray free rotary die cut. FIG. 1C illustrates generally an example web path associated with the example kiss-cut die station 100 of FIGS. 1A and 1B. In certain examples, the kiss-cut die station 100 can include a liner infeed nip 101, a die stack 102 and a controller 103. The die stack 102 can include vacuum liner die 104, a vacuum anvil 105 and a kiss-cut die 106. Each rotary element of the die stack 102 can include bearing blocks sized and shaped to slide into slots of a die station frame 107. The die station frame 107 can include a drive shaft 108 that can be driven by a motor (not shown), such as a servo motor. Gears on each of the rotary elements of the die stack 102 can engage with each other. A gear on the kiss-cut die 106 can engage with a gear on the drive shaft 108 to provide motive power and movement to each element of the die stack 102. In certain examples, each of the rotary elements of the die stack 102 can be driven by a separate motor. In some examples, combinations of rotary elements can be driven by a combination of motors. In certain examples, the liner infeed nip is driven by a motor 109, such as a servo motor. In certain examples, die clamps 110 can be used to apply pressure on the die stack 102 or on the rolls 112, 113 of the infeed nip 101. In some examples, pressure gauges 111 can provide pressure feedback from the die clamps 110 and can be used to diagnose die problems or monitor die blade life cycles.

The overall function of the die station 100 is to die cut production material 120 using the kiss-cut die 106 and provide the cut production material 121 to a downstream area. To provide high quality die cuts, the example kiss-cut die station 100 provides and recycles lengths of liner material 130 in such a fashion that compared to the length of production material 120 used over an extended period of time, only a fraction of that length of liner material 130 is required. In addition, the example kiss-cut die station 100 can recycle the liner material 130 as it is used so that several roll changes of production material 120 can be made before a new roll of liner material 130 is required, thus saving production cost over traditional liner kiss cut operations.

The operation of the example kiss-cut die station 100 is discussed below based on a length of liner material 130 being used for multiple die-cut cycles. It is understood that the number of times an example kiss-cut die station 100 can re-use a length of liner material 130 can depend on several factors and the number of re-use cycles of the liner material 130 can vary significantly without departing from the present subject matter. In normal operation, the die stack 102 can be moving in a continuous manner. At the beginning of a liner cycle, the liner infeed nip 101 can feed a length of liner into the die stack 102 of the kiss-cut die station 100. The vacuum die 104 can include a sheet cut die blade 114 and can be hollow to accommodate connection of the interior of the vacuum die 104 to a negative pressure source (not shown) such as a vacuum pump. The vacuum die 104 can include holes in the surface such that when the liner material 130 is place near the surface of the vacuum die 104, the liner material 130 can cling to the vacuum die 104. As the liner infeed nip 101 feeds a length of liner material 130 into the die stack 102, the liner material 130 can cling to the vacuum die 104 and be die cut against the vacuum anvil 105. In certain examples, the interior of the vacuum die 104 can include a vacuum manifold that only exposes a portion of the die surface to the negative pressure such that as the liner is cut by the vacuum die 104 at the vacuum anvil 105, the negative pressure holding the liner to the vacuum die 104 after the die cut is removed. Once a predetermined length of liner material is indexed into the die stack 102, the infeed nip station stops feeding liner material 130 until another length of liner material 130 is needed. In certain examples, the next infeed of liner material 130 does not occur for several die cut cycles of the die stack 102.

As the leading edge of the liner material 130 begins to pass between the vacuum die 104 and the vacuum anvil 105 and the vacuum holding the liner material 130 to the vacuum die 104 is removed via the manifold internal to the vacuum die 104, the liner material 130 can transfer to the vacuum anvil 105. The vacuum anvil 105 includes a hard face for making rotary die cuts. In certain examples, the vacuum anvil 105 also includes one or more interior manifold chambers for allowing holes in the surface of the vacuum anvil 105 to be exposed to positive or negative pressure sources. As the blade 114 of the vacuum die 104 engages the vacuum anvil 105, the liner material 130 is cut or sheeted to provide a liner sheet 131. Once transferred to the vacuum anvil 105, the liner sheet 131 can rotate with the vacuum anvil 105 for several kiss-cut cycles.

In general, during a kiss-cut cycle, the die stack 102 receives production material 120 and the liner sheet 131 between the vacuum anvil 105 and the kiss-cut die 106. As the vacuum anvil 105 and the kiss-cut die 106 rotate, the kiss-cut die cuts completely through the production material 120 and only partially penetrates the liner sheet 131. Upon further rotation of the die stack 102, the liner sheet 131 can continue to cling to the vacuum anvil 105 and piece parts 121 associated with the production material 120 can be conveyed down web. In certain examples, waste production material, such as a waste matrix 122 can be pulled away from the die stack 102 and disposed of.

In certain examples, the gearing of the vacuum anvil 105 and the kiss-cut die 106 can be slightly offset from a 1:1 surface speed ratio such that at each successive kiss cut cycle the kiss-cut die 106 does not completely overlay the immediately prior kiss-cut images that may be on the liner sheet 131. In certain examples, the quality of the kiss-cut can be less when a kiss-cut lines up with prior kiss-cut image embossed on the liner sheet 131. In certain examples, the repeat length of the kiss-cut die 106 can impact the number of times the liner sheet 131 can be used. As the last cycle of the predetermined number of kiss-cut cycles of the liner sheet 131 occurs, a manifold of the vacuum anvil 105 can be exposed to a positive pressure source such that just after the leading edge 132 of the liner sheet 131 exits the kiss-cutting operation, the positive pressure can separate the leading edge 132 of the liner sheet 131 from the vacuum anvil 105 as shown by the dashed line at 133. In certain examples, another mechanism such as a vacuum hood or waste conveyor can capture the leading edge 132 of the spent liner sheet 131 and dispose of it. It is during this last cycle of the liner sheet 131 that another length of liner material 130 can be fed into the die stack 102 by the liner infeed nip 101 and the operation can begin anew.

In certain examples, the die station 101 can include a cross web motion system 117 capable of moving either the vacuum anvil 105 or the kiss-cut die 106 in the cross-web direction. In some examples, the cross web motion system 117 can include a servo motor 118 and can be synchronized with the kiss-cut cycle such that successive kiss-cuts can occur at different cross web locations of the liner sheet 131.

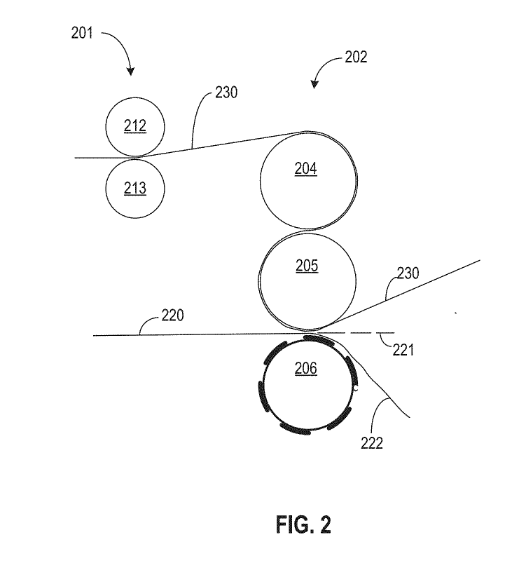

FIG. 2 illustrates generally an alternative web path for an example kiss-cut die station. The kiss-cut station can include a liner infeed nip 201, and a die stack 202. The liner infeed nip 201 can include a pair of nip rolls 212, 213. The die stack can include a vacuum pull roll 204, a vacuum anvil 205 and a kiss-cut die 206. As the die station rotates, the liner material 130 is used as a backing when the kiss-cut die 206 cuts through the production material 220 against the vacuum anvil 205 to provide piece parts 221. Between kiss-cut cycles, the infeed nip reverses direction and retracts liner material from the die stack. In certain examples, the next kiss-cut cycle can reuse nearly all the liner material from the previous cycle.

After the kiss-cut operation, the piece parts 222 can be captured, for example, by a conveyor for further processing. If a production material matrix 222 is produced, additional operations can, for example, rewind the production material matrix 222 or chop the production material matrix 222 for subsequent disposal. In certain examples, the used liner material 230 can be rewound or chopped for subsequent disposal. In certain examples, the liner infeed nip 201 can be located to the right of the die stack 202. In such an example, vacuum pull roll 204 can be optional.

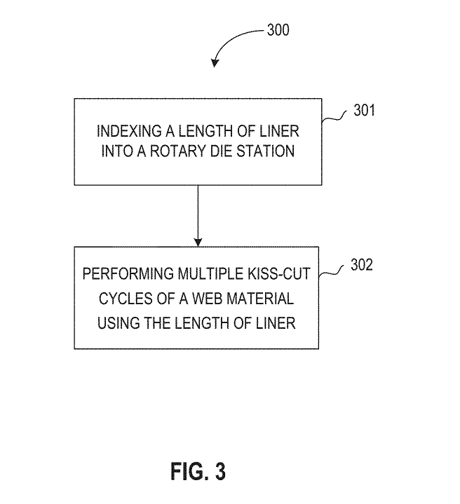

FIG. 3 illustrates generally a flowchart of an example method 300 of operating an example kiss-cut die station. At 301, a liner infeed nip station can index a length of liner into a rotary die station. At 303, the rotary die station can perform multiple kiss-cut cycles using the length of liner material.

In certain examples, the die station can sheet the liner material and cycle the sheet of liner material as a backing material through several kiss-cut die cutting cycles. In certain examples, a rotary vacuum anvil can use vacuum to have the sheet of liner material stay in place throughout the multiple kiss-cut cycles. In certain examples, the vacuum anvil and the kiss-cut die can be geared such that each kiss-cut of the liner sheet is offset from a previous kiss cut of the liner sheet. Such a system can allow the web material to be cut without fraying while using a fraction of the liner material compared to the web material. In certain examples, a controller controls the motors driving the liner infeed nip station, the rotary die station, the switching of the positive and negative pressure sources to the die manifolds as well as other operation associated with the overall system including the example kiss-cut die station. In certain examples, the nip station is completely stopped or idle while a sheet of liner material is being used for several kiss-cut cycles. During the idle time, the controller can use the nip station to retract some liner material out of the die stack. Upon indexing the next length of liner material into the die stack, the controller can use the retracted distance of liner to more gently ramp the nip station up to speed with the moving vacuum die such that the blade of the vacuum die is position just in front of the leading edge of the liner material as the nip station synchronizes speed with the vacuum die.

In some examples, vacuum rol

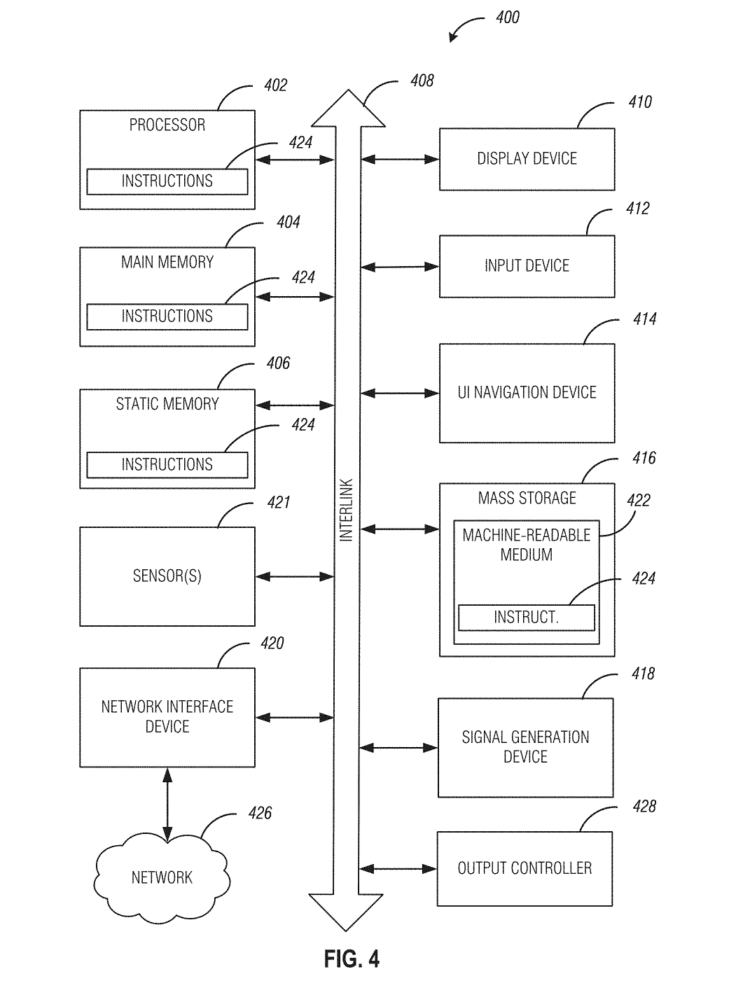

FIG. 4 illustrates a block diagram of an example machine 400 or controller upon which any one or more of the techniques (e.g., methodologies) discussed herein may perform. In alternative embodiments, the machine 400 may operate as a standalone device or may be connected (e.g., networked) to other machines. In a networked deployment, the machine 400 may operate in the capacity of a server machine, a client machine, or both in server-client network environments. In an example, the machine 400 may act as a peer machine in peer-to-peer (P2P) (or other distributed) network environment. The machine 400 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets (also known as a group of circuits or circuit groups) are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 400 may include a hardware processor 402 (e.g., a central processing unit (CPU), a graphics processing unit (GPU), a hardware processor core, or any combination thereof), a main memory 404 and a static memory 406, some or all of which may communicate with each other via an interlink (e.g., bus) 408. The machine 400 may further include a display unit 410, an alphanumeric input device 412 (e.g., a keyboard), and a user interface (UI) navigation device 414 (e.g., a mouse). In an example, the display unit 410, input device 412 and UI navigation device 414 may be a touch screen display. The machine 400 may additionally include a storage device (e.g., drive unit) 416, a signal generation device 418 (e.g., a speaker), a network interface device 420, and one or more sensors 421, such as a global positioning system (GPS) sensor, compass, accelerometer, or other sensor. The machine 400 may include an output controller 428, such as a serial (e.g., universal serial bus (USB), parallel, or other wired or wireless (e.g., infrared (IR), NFC, etc.) connection to communicate or control one or more peripheral devices (e.g., a printer, card reader, etc.).

The storage device 416 may include a machine readable medium 422 on which is stored one or more sets of data structures or instructions 424 (e.g., software) embodying or utilized by any one or more of the techniques or functions described herein. The instructions 424 may also reside, completely or at least partially, within the main memory 404, within static memory 406, or within the hardware processor 402 during execution thereof by the machine 400. In an example, one or any combination of the hardware processor 402, the main memory 404, the static memory 406, or the storage device 416 may constitute machine readable media.

While the machine readable medium 422 is illustrated as a single medium, the term “machine readable medium” may include a single medium or multiple media (e.g., a centralized or distributed database, and/or associated caches and servers) configured to store the one or more instructions 424.

The term “machine readable medium” may include any medium that is capable of storing, encoding, or carrying instructions for execution by the machine 400 and that cause the machine 400 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 424 may further be transmitted or received over a communications network 426 using a transmission medium via the network interface device 420 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 420 may include one or more physical jacks (e.g., Ethernet, coaxial, or phone jacks) or one or more antennas to connect to the communications network 426. In an example, the network interface device 420 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 400, and includes digital or analog communications signals or other intangible medium to facilitate communication of such software.

### Examples and Notes

In Example 1, an apparatus for kiss cutting a moving web of material can include a rotary die station configured to receive the web of material and a length of kiss-cut liner, and to perform multiple kiss-cut cycles of the web material and the length of kiss-cut liner. A length of the length of kiss-cut liner can be commensurate with a repeat length of a die of the rotary die station. The length of kiss-cut liner can provide a backing material for each kiss-cut cycle of the multiple kiss-cut cycles. The rotary die station can be configured to completely cut through a new length of web material during each kiss-cut cycle of the multiple kiss-cut cycles.

In Example 2, the apparatus of Example 1 can optionally include a nip station configured to feed a length of kiss-cut liner.

In Example 3, the rotary die station of any one or more of Examples 1-2 optionally includes a rotary kiss cut die configured cut the moving web of material and to simultaneously kiss-cut the length of kiss-cut liner, and a rotary vacuum anvil configured to provide an anvil surface for the rotary kiss-cut die and to retain a portion of the kiss-cut liner next to an external surface of the rotary vacuum anvil using vacuum applied to an internal manifold of the rotary vacuum anvil.

In Example 4, the die station of any one or more of Examples 1-3 optionally is configured to receive the kiss-cut liner between the rotary vacuum anvil and the rotary kiss-cut die.

In Example 5, the first length of any one or more of Examples 1-4 optionally is substantially equal to a repeat length of rotary kiss-cut die, and the second length of any one or more of Examples 1-4 optionally is less than the repeat length of the kiss-cut die.

In Example 6, the die station of any one or more of Examples 1-5 optionally includes a rotary kiss-cut die configured to kiss cut the moving web of material, a rotary sheeter die configured to sheet cut the kiss-cut liner, and a rotary anvil positioned between the rotary kiss-cut die and the rotary sheeter die, the rotary anvil configured to support a kiss cut cycle of the rotary kiss-cut die and to support a sheet cut cycle of the rotary sheeter die.

In Example 7, the rotary anvil of any one or more of Examples 1-6 optionally is configured to wrap a first sheet of kiss-cut liner about the rotary anvil to provide a wrapped position of the first sheet and to maintain the wrapped position of first sheet of kiss cut liner for a plurality of rotary cycles of the rotary anvil.

In Example 8, the wrapped position of the sheet to the rotary anvil of any one or more of Examples 1-7 optionally is maintained using electrostatic cling.

In Example 9, the wrapped position of the first sheet of any one or more of Examples 1-8 optionally is maintained using vacuum applied to a manifold of the rotary anvil.

In Example 10, a leading edge of the first sheet of any one or more of Examples 1-9 optionally is displaced from the wrapped position using air pressure applied to the manifold of the rotary anvil.

In Example 11, the kiss-cut liner of any one or more of Examples 1-10 optionally includes a polyester liner.

In Example 12, the kiss-cut liner of any one or more of Examples 1-11 optionally includes a paper liner.

In Example 13, the web of material of any one or more of Examples 1-12 optionally includes a metal foil.

In Example 14, the metal foil of any one or more of Examples 1-13 optionally includes an aluminum foil.

In Example 15, the web of material of any one or more of Examples 1-14 optionally includes a non-woven material.

In Example 16, a method can include indexing a length of liner into a rotary die station, and performing multiple kiss-cut cycles of a web material. The length of liner is a backing material for each kiss-cut cycle of the multiple kiss-cut cycles and each kiss-cut cycle of the multiple kiss-cut cycles is configured to completely cut through a new length of the web material.

In Example 17, the method of any one or more of Examples 1-16 optionally includes drawing the liner into the rotary die station using vacuum applied to a rotary vacuum die of the rotary die station.

In Example 18, the method of any one or more of Examples 1-17 optionally includes cutting the liner using the rotary vacuum die and a rotary vacuum anvil of the rotary die station to provide the sheet of liner.

In Example 19, the method of any one or more of Examples 1-18 optionally includes transferring the sheet of liner to the rotary vacuum anvil using vacuum applied to the rotary vacuum anvil.

In Example 20, the method of any one or more of Examples 1-19 optionally includes maintaining the sheet of liner in place about a face of the rotary vacuum anvil through the multiple kiss-cut cycles using the vacuum applied to the vacuum anvil.

In Example 21, the method of any one or more of Examples 1-20 optionally includes applying a positive pressure to an internal manifold of the rotary vacuum anvil and removing the sheet of liner from the face of the rotary vacuum anvil using the positive pressure.

In Example 22, the method of any one or more of Examples 1-12 optionally includes retracting a second length of liner from the rotary die station in reparation for a subsequent index of the liner material.

In Example 23, an apparatus for kiss cutting a moving web of material can include a nip station configured to feed a length of kiss-cut liner, and a rotary die station configured to receive the web of material and the length of kiss-cut liner, and to perform multiple kiss-cut cycles of the web material to cut the through the web material and kiss-cut the kiss cut liner. The nip station can be configured to control the nip station to advance a first length of kiss-cut liner into the die station to support a first kiss cut cycle of the web of material and to retract a second length of kiss cut material from the die station in preparation for a second kiss-cut cycle of the web material.

In Example 24, the die station of any one or more of Examples 1-23 optionally includes a rotary kiss cut die configured kiss cut the moving web of material and a rotary vacuum anvil configured to provide an anvil surface for the rotary kiss-cut die and to retain a portion of the kiss-cut liner next to an external surface of the anvil using vacuum.

In Example 25, the die station of any one or more of Examples 1-23 optionally is configured to receive the kiss-cut liner between the rotary vacuum anvil and the rotary kiss-cut die.

In Example 26, the first length of any one or more of Examples 1-25 optionally is substantially equal to a repeat length of rotary kiss-cut die, and the second length of any one or more of Examples 1-25 optionally is less than the repeat length of the kiss-cut die.

In Example 27, the die station of any one or more of Examples 1-26 optionally includes a rotary kiss-cut die configured to kiss cut the moving web of material, a rotary sheeter die configured to sheet cut the kiss-cut liner, and a rotary anvil positioned between the rotary kiss-cut die and the rotary sheeter die, the rotary anvil configured to support a kiss cut cycle of the rotary kiss-cut die and to support a sheet cut cycle of the rotary sheeter die.

In Example 28, the rotary anvil of any one or more of Examples 1-27 optionally is configured to wrap a first sheet of kiss-cut liner about the rotary anvil to provide a wrapped position of the first sheet and to maintain the wrapped position of first sheet of kiss cut liner for a plurality of rotary cycles of the rotary anvil.

In Example 29, the wrapped position of the sheet to the rotary anvil of any one or more of Examples 1-28 optionally is maintained using electrostatic cling.

In Example 30, the wrapped position of the first sheet of any one or more of Examples 1-29 optionally is maintained using vacuum applied to a manifold of the rotary anvil.

In Example 31, a leading edge of the first sheet of any one or more of Examples 1-30 optionally is displaced from the wrapped position using air pressure applied to the manifold of the rotary anvil.

In Example 32, the kiss-cut liner of any one or more of Examples 1-31 optionally includes a polyester liner.

In Example 33, the kiss-cut liner of any one or more of Examples 1-32 optionally includes a paper liner.

In Example 34, the web of material of any one or more of Examples 1-33 optionally includes a metal foil.

In Example 35, the metal foil of any one or more of Examples 1-34 optionally includes an aluminum foil.

In Example 36, the web of material of any one or more of Examples 1-35 optionally includes a non-woven material.

The above detailed description includes references to the accompanying drawings, which form a part of the detailed description. The drawings show, by way of illustration, specific embodiments in which the invention can be practiced. These embodiments are also referred to herein as “examples.” All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of“at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. Method examples described herein can be machine or computer-implemented at least in part.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

What is claimed is:

1. An apparatus for kiss cutting a moving web of material, the apparatus comprising:
a rotary die station configured to receive the web of material and a length of kiss-cut liner, and to perform multiple kiss-cut cycles of the web material and the length of kiss-cut liner,
wherein a length of the length of kiss-cut liner is commensurate with a repeat length of a die of the rotary die station,
wherein the length of kiss-cut liner provides a backing material for each kiss-cut cycle of the multiple kiss-cut cycles, and
wherein the rotary die station is configured to completely cut through a new length of web material during each kiss-cut cycle of the multiple kiss-cut cycles.

2. The apparatus of claim 1, comprising a nip station configured to feed a length of kiss-cut liner.

3. The apparatus of claim 1, wherein the rotary die station includes a rotary kiss cut die configured cut the moving web of material and to simultaneously kiss-cut the length of kiss-cut liner; and
a rotary vacuum anvil configured to provide an anvil surface for the rotary kiss-cut die and to retain a portion of the kiss-cut liner next to an external surface of the rotary vacuum anvil using vacuum applied to an internal manifold of the rotary vacuum anvil.

4. The apparatus of claim 3, wherein the die station is configured to receive the kiss-cut liner between the rotary vacuum anvil and the rotary kiss-cut die.

5. The apparatus of claim 3, wherein the first length is substantially equal to a repeat length of rotary kiss-cut die; and
wherein the second length is less than the repeat length of the kiss-cut die.

6. The apparatus of claim of claim 1, wherein the die station includes:
a rotary kiss-cut die configured to kiss cut the moving web of material;
a rotary sheeter die configured to sheet cut the kiss-cut liner; and
a rotary anvil positioned between the rotary kiss-cut die and the rotary sheeter die, the rotary anvil configured to support a kiss cut cycle of the rotary kiss-cut die and to support a sheet cut cycle of the rotary sheeter die.

7. The apparatus of claim 6, wherein the rotary anvil is configured to wrap a first sheet of kiss-cut liner about the rotary anvil to provide a wrapped position of the first sheet and to maintain the wrapped position of first sheet of kiss cut liner for a plurality of rotary cycles of the rotary anvil.

8. The apparatus of claim 7, wherein the wrapped position of the sheet to the rotary anvil is maintained using electrostatic cling.

9. The apparatus of claim 7, wherein the wrapped position of the first sheet is maintained using vacuum applied to a manifold of the rotary anvil.

10. The apparatus of claim 7, wherein a leading edge of the first sheet is displaced from the wrapped position using air pressure applied to the manifold of the rotary anvil.

11. The apparatus of claim 1, wherein the kiss-cut liner includes a polyester liner.

12. The apparatus of claim 1, wherein the kiss-cut liner includes a paper liner.

13. The apparatus of claim 1, wherein the web of material includes a metal foil.

14. The apparatus of claim 13, wherein the metal foil includes an aluminum foil.

15. The apparatus of claim 1, wherein the web of material includes a non-woven material.

16. A method comprising:
indexing a length of liner into a rotary die station; and
performing multiple kiss-cut cycles of a web material,
wherein the length of liner is a backing material for each kiss-cut cycle of the multiple kiss-cut cycles, and
wherein each kiss-cut cycle of the multiple kiss-cut cycles is configured to completely cut through a new length of the web material.

17. The method of claim 16, including drawing the liner into the rotary die station using vacuum applied to a rotary vacuum die of the rotary die station.

18. The method of claim 17, including cutting the liner using the rotary vacuum die and a rotary vacuum anvil of the rotary die station to provide the sheet of liner.

19. The method of claim 18, including transferring the sheet of liner to the rotary vacuum anvil using vacuum applied to the rotary vacuum anvil.

20. The method of claim 19, including maintaining the sheet of liner in place about a face of the rotary vacuum anvil through the multiple kiss-cut cycles using the vacuum applied to the vacuum anvil.

21. The method of claim 20, including applying a positive pressure to an internal manifold of the rotary vacuum anvil; and
removing the sheet of liner from the face of the rotary vacuum anvil using the positive pressure.

22. The method of claim 16, including retracting a second length of liner from the rotary die station in reparation for a subsequent index of the liner material.
